(19) United States
(12) Patent Application Publication
(10) Pub. No.: US 2019/0012689 A1
(43) Pub. Date: Jan. 10, 2019

(54) System, Method, and Computer Program Product for Providing a Transaction Offset Based on a Transaction

(71) Applicant: Visa International Service Association, San Francisco, CA (US)

(72) Inventor: Rajesh Kumar Aroli Veettil, Singapore (SG)

(21) Appl. No.: 15/643,917

(22) Filed: Jul. 7, 2017

(51) Int. Cl. G06Q 30/02

(52) U.S. Cl. CPC G06Q 30/0224

(57) ABSTRACT

Provided is a computer-implemented method for providing a transaction offset based on a transaction. The method may include receiving information associated with a first transaction, determining to generate a transaction offset based at least partially on the information associated with the first transaction and at least one merchant redemption rule, where determining to generate the transaction offset includes accessing a data structure that is independent of the at least one merchant; generating the transaction offset; communicating a message based on generating the transaction offset; receiving information associated with a second transaction; determining whether to process the second transaction by applying the transaction offset to the second transaction based at least partially on the information associated with the second transaction and information associated with the transaction offset; and processing the second transaction by applying the transaction offset to the second transaction. A system and computer program product are also disclosed.

### BACKGROUND OF THE INVENTION

### 1. Field of the Invention

This invention relates generally to systems, devices, products, apparatus, and methods that provide transaction offsets and, in one particular embodiment, to a system, product, and method for providing transaction offsets that may be based on a transaction.

### 2. Technical Considerations

A merchant loyalty program (e.g., a customer loyalty program, etc.) may be a structured marketing strategy provided by a merchant to encourage a customer to purchase goods or services of the merchant. For example, a merchant loyalty program may provide a reward to a customer that provides the customer with a monetary discount if the customer purchases a specified monetary amount of goods or services from the merchant. Various categories of merchants may be associated with merchant loyalty programs, and each merchant loyalty program may have varying features and schemes for providing rewards.

A chargeback may be the return of funds to a customer from a merchant that is forcibly initiated by an issuer (e.g., an issuing bank) of a financial instrument used by a customer during a transaction involving the customer and the merchant. For example, a chargeback may be the reversal of a prior, outbound transfer of funds from the customer's account to the merchant's account. The chargeback may be the result of a product sold by the merchant that failed to meet a quality standard, a failure of a merchant to provide a product to the customer (e.g., in an online setting), duplicate processing of a transaction involving the customer and the merchant, or the like.

In some situations, a merchant may provide a customer some form of benefit, such as a reward associated with a merchant loyalty program, following a chargeback so that the customer will continue to purchase or purchase additional goods or services of the merchant. However, the merchant may lack an efficient and/or discernible way to provide the reward associated with merchant loyalty program to the customer based on the chargeback. For example, the merchant may not have a way to contact the customer, such as via an email address, mailing address, or phone number. In addition, the merchant may not have access to information regarding the customer (e.g., how often the customer makes purchases from the merchant, how much the customer purchases from the merchant, and/or the like), so that the merchant may not be able to determine whether providing the reward to the customer is worthwhile. Additionally, while a computer system may allow for the merchant to store and access the information regarding the customer, such a computer system may be expensive and unaffordable to the merchant.

Additionally, in some situations, the customer may fail to use the reward provided to the customer by the merchant. For example, the customer may forget about the reward and fail to provide the reward (e.g., by presenting a code that can be scanned by the merchant or by presenting a document with a code) during a transaction with the merchant.

### SUMMARY OF THE INVENTION

Accordingly, it is an object of the present invention to provide systems, devices, products, apparatus, and/or methods for providing a transaction offset based on a transaction that overcomes some or all of the deficiencies of the prior art. According to a non-limiting embodiment, provided is a computer-implemented method for providing a transaction offset based on a transaction. The method comprises receiving, with at least one processor, information associated with a first transaction between at least one customer and at least one merchant; determining, with at least one processor, to generate a transaction offset based at least partially on the information associated with the first transaction and at least one merchant redemption rule, wherein determining to generate the transaction offset comprises accessing a data structure that is independent of the at least one merchant; generating, with at least one processor, the transaction offset based on determining to generate the transaction offset; communicating, with at least one processor, a transaction offset notification message based on generating the transaction offset; receiving, with at least one processor, information associated with a second transaction involving the at least one customer and the at least one merchant; determining, with at least one processor, whether to process the second transaction by applying the transaction offset to the second transaction based at least partially on the information associated with the second transaction and information associated with the transaction offset; and processing, with at least one processor, the second transaction by applying the transaction offset to the second transaction based on determining to process the second transaction by applying the transaction offset to the second transaction.

According to another non-limiting embodiment, provided is a system for providing a transaction offset based on a transaction. The system comprises at least one processor, wherein the at least one processor is programmed or configured to: receive information associated with a first transaction between at least one customer and at least one merchant; determine to generate a transaction offset based at least partially on the information associated with the first transaction and at least one merchant redemption rule, wherein the at least one processor, when determining to generate the transaction offset, is to access a data structure that is independent of the at least one merchant; generate the transaction offset based on determining to generate the transaction offset, wherein the transaction offset comprises transaction offset application parameters; communicate a message based on generating the transaction offset; receive information associated with a second transaction involving the at least one customer and the at least one merchant; determine whether to process the second transaction by applying the transaction offset to the second transaction based at least partially on the information associated with the second transaction and transaction offset application parameters of the transaction offset; and process the second transaction by applying the transaction offset to the second transaction based on determining to process the second transaction by applying the transaction offset.

According to a further non-limiting embodiment, provided is a computer program product for providing a transaction offset based on a transaction. The computer program product comprises at least one non-transitory computer-readable medium including one or more instructions that, when executed by at least one processor, cause the at least one processor to: receive information associated with a first transaction between at least one customer and at least one merchant; determine to generate a transaction offset based at least partially on the information associated with the first transaction and at least one merchant redemption rule, where the one or more instructions, that cause the at least one processor to determine to generate the transaction offset, cause the at least one processor to access a data structure that is independent of the at least one merchant; generate the transaction offset based on determining to generate the transaction offset; communicate a transaction offset notification message; receive information associated with a second transaction involving the at least one customer and the at least one merchant; determine whether to process the second transaction by applying the transaction offset to the second transaction based at least partially on the information associated with the second transaction; and process the second transaction by applying the transaction offset to the second transaction based on determining to process the second transaction by applying the transaction offset.

Further embodiments or aspects are set forth in the following numbered clauses:

Clause 1: A computer-implemented method, comprising: receiving, with at least one processor, information associated with a first transaction between at least one customer and at least one merchant; determining, with at least one processor, to generate a transaction offset based at least partially on the information associated with the first transaction and at least one merchant redemption rule, wherein determining to generate the transaction offset comprises accessing a data structure that is independent of the at least one merchant; generating, with at least one processor, the transaction offset based on determining to generate the transaction offset; communicating, with at least one processor, a transaction offset notification message based on generating the transaction offset; receiving, with at least one processor, information associated with a second transaction involving the at least one customer and the at least one merchant; determining, with at least one processor, whether to process the second transaction by applying the transaction offset to the second transaction based at least partially on the information associated with the second transaction and information associated with the transaction offset; and processing, with at least one processor, the second transaction by applying the transaction offset to the second transaction based on determining to process the second transaction by applying the transaction offset to the second transaction.

Clause 2: The computer-implemented method of clause 1, wherein receiving the information associated with the first transaction comprises receiving a transaction offset generation request from a client device associated with the at least one merchant, wherein the transaction offset generation request comprises the information associated with the first transaction.

Clause 3: The computer-implemented method of clauses 1 or 2, wherein the information associated with the transaction offset comprises at least one transaction offset application parameter, wherein the at least one transaction offset application parameter comprises at least one of: a threshold value associated with a transaction amount of a transaction, a threshold value associated with a time of a transaction, predetermined information associated with an identity of a merchant, predetermined information associated with an additional merchant, where the additional merchant has a relationship with the at least one merchant, predetermined information associated with an identity of a user, or any combination thereof.

Clause 4: The computer-implemented method of any of clauses 1-3, wherein the at least one merchant redemption rule comprises merchant redemption rule criteria, wherein the merchant redemption rule criteria comprises at least one of: a threshold value associated with a transaction amount of a transaction, a threshold value associated with a time of a transaction, a predetermined threshold value of a number of transactions involving the at least one customer and the at least one merchant, information associated with at least one additional merchant, or any combination thereof.

Clause 5: The computer-implemented method of any of clauses 1-4, wherein the information associated with the first transaction comprises a transaction amount of the first transaction, and wherein determining to generate the transaction offset comprises: determining to generate a transaction offset based at least partially on the transaction amount of the first transaction and the at least one merchant redemption rule.

Clause 6: The computer-implemented method of any of clauses 1-5, further comprising receiving merchant redemption rule criteria associated with the at least one merchant redemption rule from the at least one merchant before receiving the information associated with the first transaction.

Clause 7: The computer-implemented method of any of clauses 1-6, wherein generating the transaction offset comprises: generating the transaction offset based on the at least one merchant redemption rule.

Clause 8: The computer-implemented method of any of clauses 1-7, further comprising receiving a request to generate a transaction offset from a client device associated with the at least one merchant, and wherein determining whether to generate the transaction offset comprises: determining to generate the transaction offset based on receiving the request to generate the transaction offset.

Clause 9: A system, comprising: at least one processor, wherein the at least one processor is programmed or configured to: receive information associated with a first transaction between at least one customer and at least one merchant; determine to generate a transaction offset based at least partially on the information associated with the first transaction and at least one merchant redemption rule, wherein the at least one processor, when determining to generate the transaction offset, is to access a data structure that is independent of the at least one merchant; generate the transaction offset based on determining to generate the transaction offset, wherein the transaction offset comprises transaction offset application parameters; communicate a message based on generating the transaction offset; receive information associated with a second transaction involving the at least one customer and the at least one merchant; determine whether to process the second transaction by applying the transaction offset to the second transaction based at least partially on the information associated with the second transaction and transaction offset application parameters of the transaction offset; and process the second transaction by applying the transaction offset to the second transaction based on determining to process the second transaction by applying the transaction offset.

Clause 10: The system of clause 9, wherein the at least one merchant is a first merchant wherein the at least one merchant redemption rule comprises merchant redemption rule criteria, wherein the merchant redemption rule criteria comprises at least one of: a threshold value associated with a transaction amount of a transaction, a threshold value associated with a time of a transaction, a threshold value of a number of transactions involving the at least one customer and the at least one merchant, information associated with a second merchant, or any combination thereof.

Clause 11: The system of clauses 9 or 10, wherein the message comprises information associated with generating the transaction offset, and wherein the at least one processor, when communicating the message, is further programmed or configured to communicate the message to at least one of: a client device associated with the at least one merchant, an issuer system associated with an issuer that issued an account associated with the at least one customer, at least one acquirer system associated with an acquirer, or any combination thereof.

Clause 12: The system of any of clauses 9-11, wherein the information associated with the second transaction comprises information associated with an identity of the at least one customer, wherein the at least one processor, when determining whether to process the second transaction by applying the transaction offset to the second transaction, is further programmed or configured to: determine whether to process the second transaction by applying the transaction offset to the second transaction based at least partially on the information associated with the identity of the at least one customer and the information associated with the second transaction.

Clause 13: The system of any of clauses 9-12, wherein the at least one processor is further programmed or configured to: communicate a transaction offset processing message based on processing the second transaction by applying the transaction offset to the second transaction.

Clause 14: The system of any of clauses 9-13, wherein the at least one processor is further programmed or configured to: determine information associated with an identity of the at least one customer based on the information associated with the first transaction; determine information associated with a transaction history involving the at least one customer and the at least one merchant based on the information associated with the identity of the at least one customer; and communicate the information associated with the transaction history involving the at least one customer and the at least one merchant to a client device associated with the at least one merchant.

Clause 15: A computer program product comprising at least one non-transitory computer-readable medium including one or more instructions that, when executed by at least one processor, cause the at least one processor to: receive information associated with a first transaction between at least one customer and at least one merchant; determine to generate a transaction offset based at least partially on the information associated with the first transaction and at least one merchant redemption rule, where the one or more instructions, that cause the at least one processor to determine to generate the transaction offset, cause the at least one processor to access a data structure that is independent of the at least one merchant; generate the transaction offset based on determining to generate the transaction offset; communicate a transaction offset notification message; receive information associated with a second transaction involving the at least one customer and the at least one merchant; determine whether to process the second transaction by applying the transaction offset to the second transaction based at least partially on the information associated with the second transaction; and process the second transaction by applying the transaction offset to the second transaction based on determining to process the second transaction by applying the transaction offset.

Clause 16: The computer program product of clause 15, wherein the information associated with the first transaction comprises at least one of: a transaction amount associated with the first transaction, information associated with an identity the at least one customer, information associated with an identity of the at least one merchant, or any combination thereof.

Clause 17: The computer program product of clauses 15 or 16, wherein the one or more instructions further cause the at least one processor to: receive merchant redemption rule criteria of the at least one merchant redemption rule from a client device associated with the at least one merchant before receiving the information associated with the first transaction.

Clause 18: The computer program product of any of clauses 15-17, wherein the one or more instructions, that cause the at least one processor to generate the transaction offset, cause the at least one processor to: generate the transaction offset based on the at least one merchant redemption rule and the information associated with the first transaction.

Clause 19: The computer program product of any of clauses 15-18, wherein the at least one merchant is a first merchant wherein the at least one merchant redemption rule comprises merchant redemption rule criteria, and wherein the merchant redemption rule criteria comprises at least one of: a predetermined threshold value of a transaction amount associated with the second transaction, a predetermined threshold value of time associated with the second transaction, a predetermined threshold value of a number of transactions involving the at least one customer and the at least one merchant, information associated with a second merchant, or any combination thereof; and wherein the one or more instructions, that cause the at least one processor to determine to generate the transaction offset, cause the at least one processor to: determine to generate the transaction offset based at least partially on the information associated with the first transaction and the merchant redemption rule criteria of the at least one merchant redemption rule.

Clause 20: The computer program product of any of clauses 15-19, wherein the one or more instructions further cause the at least one processor to: communicate a transaction offset processing message based on processing the second transaction by applying the transaction offset to the second transaction.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a diagram of a non-limiting embodiment of an environment in which systems, devices, products, apparatus, and/or methods, described herein, may implemented according to the principles of the present invention;

FIG. 2 is a diagram of a non-limiting embodiment of components of one or more devices of FIG. 1;

FIG. 3 is a flowchart of a non-limiting embodiment of a process for providing a transaction offset based on a transaction according to the principles of the present invention;

FIG. 4 is a flowchart of a non-limiting embodiment of a process for communicating information associated with generating a transaction offset according to the principles of the present invention; and

FIG. 5 is a sequence diagram of a non-limiting embodiment of a process for providing a transaction offset based on a transaction according to the principles of the present invention.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects of the embodiments disclosed herein are not to be considered as limiting unless otherwise indicated.

No element, act, function, or instruction used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. It will be appreciated that numerous other arrangements are possible.

As used herein, the terms “issuing institution,” “portable financial device issuer,” “issuer,” or “issuer bank” may refer to one or more entities that provide accounts to customers for conducting payment transactions, such as initiating credit and/or debit payments. For example, an issuing institution may provide an account identifier, such as a personal account number (PAN), to a customer that uniquely identifies one or more accounts associated with that customer. The account identifier may be embodied on a portable financial device, such as a physical financial instrument, e.g., a payment card, and/or may be electronic and used for electronic payments. The terms “issuing institution” and “issuing institution system” may also refer to one or more computer systems operated by or on behalf of an issuing institution, such as a server computer executing one or more software applications. For example, an issuing institution system may include one or more authorization servers for authorizing a payment transaction.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes. An issuing institution may be associated with a bank identification number (BIN) that uniquely identifies it.

As used herein, the term “account identifier” may include one or more types of identifiers associated with a user account (e.g., a PAN, a primary account number, a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payments. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of identifier. Account identifiers may be alphanumeric, any combination of characters and/or symbols, and/or the like.

As used herein, the term “token” may refer to an identifier that is used as a substitute or replacement identifier for an account identifier, such as a PAN. Tokens may be associated with a PAN or other account identifiers in one or more data structures such that they can be used to conduct a transaction without directly using the account identifier, such as a PAN. In some examples, an account identifier, such as a PAN, may be associated with a plurality of tokens for different uses or different purposes.

As used herein, the term “merchant” may refer to one or more entities (e.g., operators of retail businesses that provides goods and/or services, and/or access to goods and/or services, to a user (e.g., a customer, a consumer, a customer of the merchant, and/or the like) based on a transaction, such as a payment transaction. As used herein “merchant system” may refer to one or more computer systems operated by or on behalf of a merchant, such as a server computer executing one or more software applications. As used herein, a “merchant point-of-sale (POS) system” may refer to one or more computers and/or peripheral devices used by a merchant to engage in payment transactions with customers, including one or more card readers, near-field communication (NFC) receivers, radio frequency identification (RFID) receivers, and/or other contactless transceivers or receivers, contact-based receivers, payment terminals, computers, servers, input devices, and/or other like devices that may be used to initiate a payment transaction. A merchant POS system may also include one or more server computers programmed or configured to process online payment transactions through webpages, mobile applications, and/or the like. As used herein, the term “product” may refer to one or more goods and/or services offered by a merchant.

As used herein, a “point-of-sale (POS) system” may refer to one or more computers and/or peripheral devices used by a merchant to engage in payment transactions with customers, including one or more card readers, NFC receivers, RFID receivers, and/or other contactless transceivers or receivers, contact-based receivers, payment terminals, computers, servers, input devices, and/or other like devices that may be used to initiate a payment transaction. A POS system (e.g., a merchant POS system) may also include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and the issuing institution. In some non-limiting embodiments, a transaction service provider may include a credit card company, a debit card company, and/or the like. As used herein, the term “transaction service provider system” may also refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “acquirer” may refer to an entity licensed by the transaction service provider and approved by the transaction service provider to originate transactions using a portable financial device associated with the transaction service provider. The transactions may include purchases, original credit transactions (OCTs), account funding transactions (AFTs), and other like payment transactions. The acquirer may be authorized by the transaction service provider to assign merchant or service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure proper due diligence occurs before signing a sponsored merchant. The acquirer may be liable for all transaction service provider programs that it operates or sponsors. The acquirer may be responsible for the acts of its payment facilitators and the merchants or its payment facilitator's sponsor. An acquirer may be a financial institution, such as a bank. As used herein, the term “acquirer system” may also refer to one or more computer systems, computer devices, and/or the like operated by or on behalf of an acquirer, such as a server executing one or more software applications.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet application, a personal digital assistant, a pager, a security card, a computer, an access card, a wireless terminal, and/or a transponder, as examples. The portable financial device may include a volatile or a non-volatile memory to store information (e.g., an account identifier, a name of the account holder, and/or the like).

As used herein, the term “payment facilitator” may refer to a payment processing system operated by or on behalf of an entity (e.g., a merchant service provider) that contracts with an acquirer to provide transaction service provider payment services, using portable financial devices of the transaction service provider, to merchants sponsored by the payment facilitator. A payment facilitator may also refer to the entity that operates such a payment processing system. The payment facilitator may monitor all merchant activity sponsored by the payment facilitator in accordance with rules, regulations, and/or the like of the transaction service provider.

As used herein, the terms “client” and “client device” may refer to one or more client-side devices or systems, remote from a transaction service provider, used to initiate or facilitate a transaction. As an example, a “client device” may refer to one or more POS systems used by a merchant or one or more acquirer host computers used by an acquirer. It will be appreciated that a client device may be any electronic device configured to communicate with one or more networks and initiate or facilitate transaction such as, but not limited to, one or more computers, portable computers, tablet computers, cellular phones, wearable devices (e.g., watches, glasses, lenses, clothing, and/or the like), personal digital assistants (PDAs), and/or other like devices. Moreover, a “client” may also refer to an entity, such as a merchant or acquirer that owns, utilizes, and/or operates a client device for initiating transactions with a transaction service provider.

As used herein, the term “server” may refer to or include one or more computing devices, such as processors, storage devices, and/or similar computer components that communicate with client devices and/or other computing devices over a network environment, such as the internet or private networks, and, in some examples, facilitate communication among other servers and/or client devices. It will be appreciated that various other arrangements are possible. As used herein, the term “system” refers to one or more computing devices or combinations of computing devices, such as but not limited to processors, servers, client devices, software applications, and/or other like components.

Non-limiting embodiments of the present invention are directed to systems, methods, and computer program products for providing a transaction offset based on a transaction. Non-limiting embodiments of the invention allow for a merchant to provide transaction offsets (e.g., rewards, transaction offsets, and/or the like) to customers in an efficient and discernible way based on a transaction. Furthermore, non-limiting embodiments of the invention allow for a merchant to avoid expenditures associated with purchasing a computer system for storing information associated with transactions, customers, and/or the like. Additionally, non-limiting embodiments of the invention provide a seamless way for customers to redeem rewards provided by a merchant.

Non-limiting embodiments of the present invention may include a computer-implemented method that comprises receiving information associated with a first transaction involving a customer and a merchant and determining to generate a transaction offset based at least partially on the information associated with the first transaction and a merchant redemption rule. In this way, processor and network resources may be reduced when compared to a merchant manually determining to generate a transaction offset based on a transaction. Further, determining to generate the transaction offset may comprise accessing a data structure that is independent of the merchant. In this way, a merchant may be able to avoid expenditures associated with purchasing a computer system for storing information associated with transactions, customers, and/or the like.

Additionally, the computer-implemented method may include generating the transaction offset based on determining to generate the transaction offset and communicating a message based on generating the transaction offset. In this way, an entity (e.g., a user, a customer of a merchant, a merchant, an acquirer, an issuer institution, and/or the like) may be made aware of when a transaction offset has been generated and is available to be applied to a transaction.

Furthermore, the computer-implemented method may include receiving information associated with a second transaction involving the customer and the merchant, determining whether to process the second transaction by applying the transaction offset based at least partially on the information associated with the second transaction and information associated with the transaction offset, and processing the second transaction by applying the transaction offset based on determining to process the second transaction. In this way, a customer is not required to present a document associated with the transaction offset so that the transaction offset may be used during processing of the second transaction. Furthermore, in this way, a seamless way for customers to redeem rewards provided by a merchant is provided.

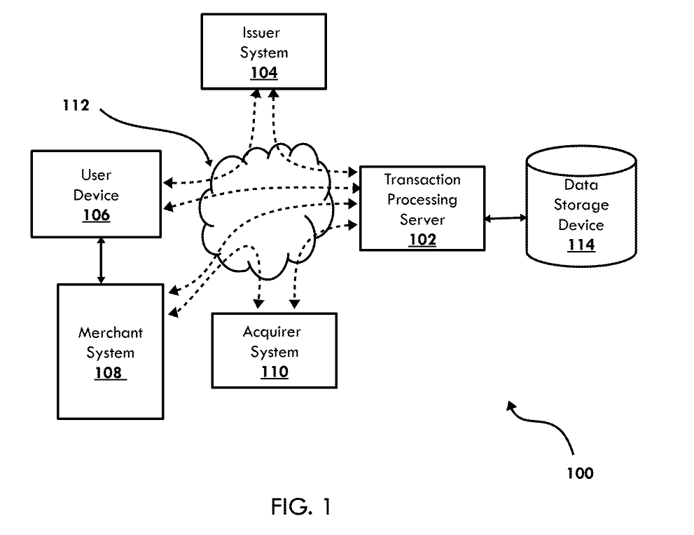

Referring now to FIG. 1, FIG. 1 is a diagram of an example environment 100 in which devices, systems, and/or methods, described herein, may be implemented. As shown in FIG. 1, environment 100 includes a transaction processing server 102, an issuer system 104, a user device 106, a merchant system 108, an acquirer system 110, and a network 112.

Transaction processing server 102 may include one or more devices capable of receiving information from issuer system 104, user device 106, merchant system 108, and/or acquirer system 110 via network 112 and/or communicating information to issuer system 104, user device 106, merchant system 108, and/or acquirer system via network 112. For example, transaction processing server 102 may include a computing device, a server, a group of servers, and/or other like devices. In some non-limiting embodiments, the transaction processing server 102 may be associated with an entity (e.g., a transaction service provider) that operates a credit card network and that processes payments for credit accounts, debit accounts, credit cards, debit cards, and/or the like. In some non-limiting embodiments, transaction processing server 102 may be in communication with a data storage device 114, which may be local or remote to the transaction processing server 102. In some non-limiting embodiments, transaction processing server 102 may be capable of receiving information from, storing information in, communicating information to, or searching information stored in data storage device 114.

Issuer system 104 may include one or more devices capable of receiving information from transaction processing server 102 and/or user device 106 via a network (e.g., network 112) and/or communicating information to transaction processing server 102 and/or user device 106 via the network. For example, issuer system 104 may include a computing device, a server, a group of servers, and/or other like devices. In some non-limiting embodiments, the issuer system 104 may be associated with an issuer institution as described herein. For example, issuer system 104 may be associated with an issuer institution that issued a credit account, debit account, credit card, debit card, and/or the like to a user associated with user device 106.

User device 106 may include one or more devices capable of receiving information from transaction processing server 102 and/or issuer system 104 via network 112 and/or communicating information to transaction processing server 102 and/or issuer system 104 via network 112. User device 106 may also include a device capable of receiving information from merchant system 108 via a network (e.g., network 112), a communication connection (e.g., an NFC) connection, an RFID communication connection, a Bluetooth® communication connection, etc.), and/or the like, or communicating information to merchant system 108 via the network, the communication connection, and/or the like. For example, user device 106 may include a client device, a computer device, a desktop computer, a laptop computer, a mobile device, a cellular phone (e.g., a smartphone, standard cellular phone, etc.), a portable computer, a wearable device (e.g., a watch, glasses, lenses, clothing, etc.), a PDA, and/or other like devices. In some non-limiting embodiments, user device 106 may be capable of engaging in a transaction with merchant system 108.

Merchant system 108 may include a device capable of receiving information from transaction processing server 102 via network 112 and/or communicating information to transaction processing server 102 via network 112. Merchant system 108 may also include a device capable of receiving information from user device 106 via a network 112, a communication connection (e.g., an NFC communication connection, an RFID communication connection, a Bluetooth® communication connection, etc.) with user device 106, and/or the like, and/or communicating information to user device 106 via the network, the communication connection, and/or the like. For example, merchant system 108 may include a computing device, a server, a group of servers, a client device, a group of client devices and/or other like devices. In some non-limiting embodiments, merchant system 108 may include one or more user devices 106. For example, merchant system 108 may include user device 106 that allows a merchant to communicate information to transaction processing server 102.

In some non-limiting embodiments, merchant system 108 may include one or more devices, computers, computer systems, and/or peripheral devices capable of being used by a merchant to engage in a transaction with a user. Merchant system 108 may include one or more magnetic stripe card readers, chip card readers, NFC receivers, RFID receivers, and/or other contactless transceivers or receivers, contact-based receivers, payment terminals, computers, servers, input devices, and/or other like devices that can be used to engage in a transaction.

In some non-limiting embodiments, merchant system 108 may include and/or be in communication with a remote POS system, which may refer to a system that performs the functions of a POS device and is hosted in a network. A remote POS system may be hosted on one or more computers instead of, or in addition to, a physical POS device at a merchant location (e.g., a retail store, etc.). A remote POS system may be hosted in or remote to the merchant location. As an example, a remote POS system may be a virtual POS system hosted in a cloud-computing environment (e.g., a cloud POS system). The remote POS system may be unique to a specific merchant and may be hosted by the merchant, by a transaction service provider, by an issuer institution, and/or by a third party.

Acquirer system 110 may include a device capable of receiving information from transaction processing server 102 and/or merchant system 108 via network 112 and/or communicating information to transaction processing server 102 and/or merchant system 108 via network 112. For example, acquirer system 110 may include a computing device, a server, a group of servers, and/or other like devices. In some non-limiting embodiments, acquirer system 110 may be associated with an acquirer as described herein.

Network 112 may include one or more wired and/or wireless networks. For example, network 112 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

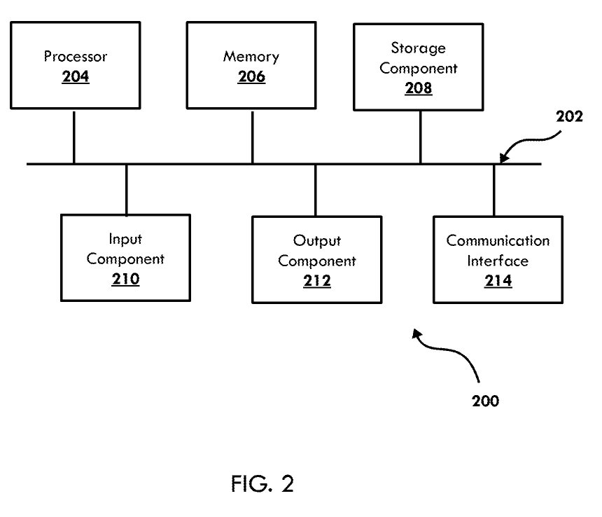

Referring now to FIG. 2, FIG. 2 is a diagram of example components of a device 200. Device 200 may correspond to transaction processing server 102, and/or one or more devices of issuer system 104, user device 106, merchant system 108, and/or acquirer system 110. In some non-limiting embodiments, transaction processing server 102, issuer system 104, user device 106, merchant system 108, and/or acquirer system 110 may include at least one device 200 and/or at least one component of device 200. As shown in FIG. 2, device 200 may include a bus 202, a processor 204, a memory 206, a storage component 208, an input component 210, an output component 212, and a communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include a random access memory (RAM), a read only memory (ROM), and/or another type of dynamic or static storage device (e.g., a flash memory, a magnetic memory, an optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

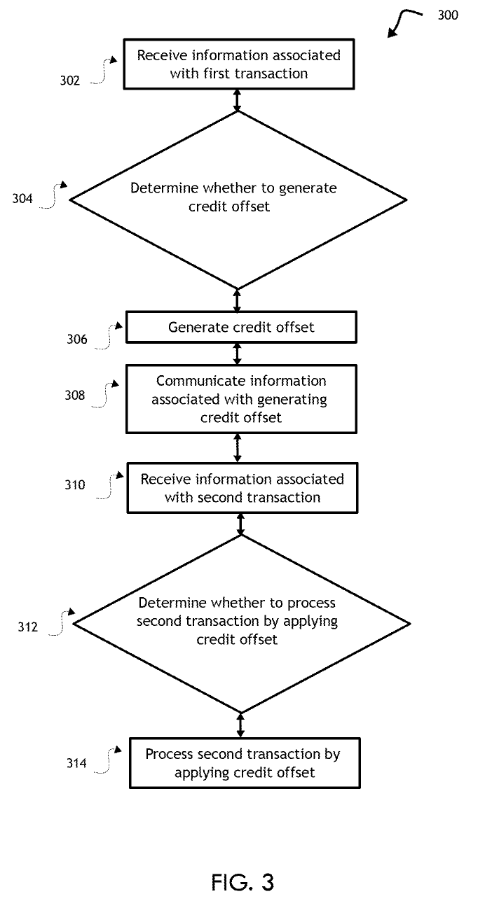

Referring now to FIG. 3, FIG. 3 is a flowchart of a non-limiting embodiment of a process 300 for providing a transaction offset based on a transaction. In some non-limiting embodiments, one or more of the steps of process 300 may be performed (e.g., completely, partially, etc.) by transaction processing server 102. In some non-limiting embodiments, one or more of the steps of process 300 may be performed (e.g., completely, partially, etc.) by another device or a group of devices separate from or including transaction processing server 102, such as issuer system 104 (e.g., one or more devices of issuer system 104), user device 106, merchant system 108 (e.g., one or more devices of merchant system 108), or acquirer system 110 (e.g., one or more devices of acquirer system 110).

As shown in FIG. 3, at step 302, process 300 includes receiving information associated with a first transaction. For example, transaction processing server 102 may receive information associated with a first transaction (e.g., automatically) from merchant system 108. In some non-limiting embodiments, transaction processing server 102 may receive information associated with a first transaction involving a customer and a merchant (e.g., a plurality of transactions involving a customer and a merchant).

In some non-limiting embodiments, the first transaction may be a past transaction (e.g., a transaction that has been authorized, cleared, and/or settled). For example, the past transaction may have been completed, settled, and/or the like before information associated with the first transaction is received by transaction processing server 102. In some non-limiting embodiments, the first transaction may be a past transaction associated with a chargeback. Accordingly, the information associated with the first transaction may include information associated with a chargeback (e.g., a chargeback code, a chargeback reason, and/or the like).

In some non-limiting embodiments, information associated with the first transaction may include information associated with a transaction amount of a transaction (e.g., a transaction amount, an overall transaction amount, a cost of each product involved, and/or the like), information associated with an identifier of a transaction (e.g., a reference number, a unique identifier, a transaction identifier, a transaction ID, a unique transaction identifier (UTI), a merchant order number, and/or the like), information associated with a product involved in a transaction (e.g., a name of the product, a name of a type of product, a stock keeping unit (SKU) number associated with a product, a merchant code associated with a product, and/or the like), information associated with a time of a transaction (e.g., a time of day, a day of the week, a day of a month, a month of a year, a predetermined time of day segment such as morning, afternoon, evening, night, and/or the like, a predetermined day of the week segment such as weekday, weekend, and/or the like, a predetermined segment of a year such as first quarter, second quarter, and/or the like, and/or the like), information associated with a transaction type of a transaction (e.g., an online transaction, a card present transaction, a face-to-face transaction, and/or the like), information associated with a transaction status of a transaction (e.g., completed, incomplete, processed, unprocessed, and/or the like), and/or the like.

Additionally or alternatively, the information associated with a transaction may include information associated with a user (e.g., a customer, a consumer, and/or the like) involved in a transaction, information associated with a merchant involved in a transaction, information associated with an issuer institution that issued an account (e.g., a credit account, a debit account, and/or the like) involved in a transaction, and/or the like.

In some non-limiting embodiments, the information associated with a user may include information associated with an identity of the user (e.g., a unique identifier of the user, a name of the user, and/or the like), information associated with an account of the user (e.g., an account identifier associated with the user, a PAN associated with a credit and/or debit account of the user, a token associated with a credit and/or debit account of the user, and/or the like), and/or the like.

In some non-limiting embodiments, the information associated with the merchant may include information associated with an identity of the merchant (e.g., a unique identifier of the merchant, a name of the merchant, and/or the like), information associated with a merchant category of the merchant (e.g., a code for a merchant category, a name of a merchant category, a type of a merchant category, and/or the like), information associated with a merchant account of the merchant (e.g., an account identifier associated with an account of the merchant, an account identifier associated with an account of the merchant provided by an acquirer associated with acquirer system 110, a PAN associated with an account of the merchant, a token associated with an account of the merchant, and/or the like), and/or the like.

In some non-limiting embodiments, the information associated with the acquirer may include information associated with an identity of the acquirer (e.g., a unique identifier of the acquirer, a name of the acquirer, and/or the like), information associated with a merchant account provided by the acquirer (e.g., an account identifier associated with a merchant account provided by the acquirer, an account identifier associated with a merchant account provided by provided by an acquirer, a PAN associated with a merchant account provided by the acquirer, a token associated with a merchant account provided by the acquirer, and/or the like), and/or the like.

In some non-limiting embodiments, the information associated with the issuer institution may include information associated with an identity of the issuer institution (e.g., a unique identifier of the issuer institution, a name of the issuer institution, an issuer identification number (IIN) associated with the issuer institution, a bank identification number (BIN) associated with the issuer institution, and/or the like), and/or the like.

In some non-limiting embodiments, transaction processing server 102 may receive information associated with an identifier of a transaction from a merchant associated with merchant system 108. In some non-limiting embodiments, the identifier may be associated with a transaction offset that was previously generated (e.g., automatically) based on the transaction. For example, the identifier may be assigned to the transaction offset in a data structure such that transaction processing server 102 may search the data structure using the identifier to retrieve information associated with the transaction offset.

In some non-limiting embodiments, transaction processing server 102 may receive a request to generate a transaction offset (e.g., a transaction offset generation request), where the request includes information associated with a transaction. For example, transaction processing server 102 may receive the request from a merchant associated with merchant system 108. The transaction processing server 102 may receive the request from a user device, a client device, a POS device, and/or the like associated with the merchant, where the merchant is associated with merchant system 108. In some non-limiting embodiments, transaction processing server 102 may communicate information associated with generating a transaction offset (e.g., information indicating that a transaction offset is to be generated or is not to be generated) to merchant system 108 based on receiving the request to generate the transaction offset.

In some non-limiting embodiments, transaction processing server 102 may receive a credential (e.g., a merchant credential, a merchant user identifier, login information of a merchant, and/or the like) from a merchant associated with merchant system 108. In some non-limiting embodiments, transaction processing server 102 may determine a credential (e.g., information associated with a transaction history of the merchant, and/or the like) of a merchant associated with merchant system 108. In some non-limiting embodiments, transaction processing server 102 may validate the credential of the merchant to provide access to a data structure that is independent of the merchant and/or merchant system 108 (e.g., independent of a merchant associated with merchant system 108). For example, transaction processing server 102 may provide access to a data structure that is associated with an entity (e.g., a transaction service provider, an issuer system, an acquirer system, and/or the like) that is independent of a merchant associated with merchant system 108. In another example, the data structure may be associated with an entity that is not owned or controlled by a merchant associated with merchant system 108. Additionally or alternatively, the data structure may be associated with an entity that is not affiliated with a merchant associated with merchant system 108 except in a context that the entity may process transactions involving the merchant. In some non-limiting embodiments, transaction processing server 102 may provide access to the data structure based on the credential.

In some non-limiting embodiments, transaction processing server 102 may receive information associated with a first transaction from merchant system 108 before or after providing access to the data structure. Transaction processing server 102 may communicate information (e.g., information associated with a transaction history of a merchant associated with merchant system 108) stored in the data structure. For example, transaction processing server 102 may retrieve the information from the data structure based on the information associated with the first transaction and may communicate the information. In some non-limiting embodiments, transaction processing server 102 may communicate information associated with a plurality of transactions or a transaction involving the merchant based on receiving information associated with the first transaction (e.g., an identifier of the transaction, a plurality of identifiers of the plurality of transactions, the information associated with an identity of the merchant, information associated with an identity of a customer, and/or the like) from merchant system 108. The plurality of transactions or the transaction may involve the merchant and a customer of the merchant. In some non-limiting embodiments, transaction processing server 102 may communicate the information based on an application programming interface (API) call from an application associated with merchant system 108 (e.g., an application associated with a user device, an application associated with a client device, an application associated with a POS device, and/or the like).

In some non-limiting embodiments, transaction processing server 102 may communicate (e.g., automatically) information associated with transaction history of a merchant (e.g., information associated with past transactions involving a merchant and a customer, a transaction amount of a past transaction involving a merchant and a customer, a number of past transactions involving a merchant and a customer, and/or the like). For example, transaction processing server 102 may communicate the information associated with the transaction history of the merchant based on receiving a credential from a merchant associated with merchant system 108.

In some non-limiting embodiments, transaction processing server 102 may communicate the information associated with a transaction history involving the merchant and a customer based on receiving information associated with the customer (e.g., information associated with an identity of the customer) from the merchant. For example, transaction processing server 102 may receive a name of a customer from merchant system 108, and transaction processing server 102 may communicate information associated with a transaction history involving the merchant and the customer to merchant system 108. In some non-limiting embodiments, transaction processing server 102 may receive an input, which includes an indication to generate a transaction offset from merchant system 108 based on communicating the information associated with the transaction history.

In some non-limiting embodiments, transaction processing server 102 may receive a request to generate a transaction offset (e.g., a transaction offset generation request) from merchant system 108 after transaction processing server 102 communicates information associated with the plurality of transactions to merchant system 108. In some non-limiting embodiments, transaction processing server 102 may communicate information associated with the plurality of transactions to merchant system 108, and a device of merchant system 108 (e.g., a user device of merchant system 108, a POS device of merchant system 108, and/or the like) may display the information in a user interface.

As further shown in FIG. 3, at step 304, process 300 includes determining whether to generate a transaction offset. For example, transaction processing server 102 may determine (e.g., automatically) whether to generate a transaction offset based on information associated with the first transaction. In some non-limiting embodiments, transaction processing server 102 may determine whether to generate the transaction offset based on receiving the information associated with the first transaction.

In some non-limiting embodiments, a transaction offset may be a reward from a merchant that is provided to a customer (e.g., a consumer, a cardholder, etc.) involved in a transaction (e.g., a transaction associated with a chargeback) with the merchant. In some non-limiting embodiments, the transaction offset may include a reward parameter. For example, the reward parameter may include a monetary discount, an additional good or service from a merchant, an additional good or service from a different merchant (e.g., an additional merchant associated with the merchant involved in the first transaction), and/or the like. In some non-limiting embodiments, the monetary discount may include a tier structure where monetary discount for a percentage of a transaction is applied based on a threshold value associated with the transaction (e.g., a predetermined threshold value of a transaction amount, a predetermined minimum threshold value of a transaction amount, a predetermined maximum threshold value of a transaction amount, and/or the like). For example, a transaction offset may allow a customer to receive a monetary discount of 5% on a transaction, which involves a merchant that provided the transaction offset, if the transaction amount of the transaction exceeds a minimum threshold value of a transaction amount.

In some non-limiting embodiments, a transaction offset may include transaction offset application parameters that are associated with a transaction to which the transaction offset is to be applied. In some non-limiting embodiments, the transaction offset application parameters may include a threshold value associated with a transaction amount of a transaction (e.g., a threshold transaction amount, a predetermined threshold value of a transaction amount, a predetermined minimum threshold value of a transaction amount, a predetermined maximum threshold value of a transaction amount, and/or the like) to which the transaction offset is to be applied, a threshold value associated with a time of a transaction (e.g., a predetermined threshold value of a time of day of a transaction (e.g., a time before or after which a transaction may take place for the transaction offset to be applied), a predetermined value of a time range associated with a transaction, a predetermined value of a time of day range associated with a transaction, a predetermined value of a date range associated with a transaction, a predetermined value of a time range from when the transaction offset was generated, and/or the like) to which the transaction offset is to be applied, predetermined information associated with an additional merchant (e.g., information associated with an identity of the additional merchant, information associated with a merchant category of the additional merchant, and/or the like) that may have a relationship with the merchant involved in the first transaction, where the additional merchant is involved in a transaction to which the transaction offset is to be applied, predetermined information associated with a product involved in a transaction to which the transaction offset is to be applied, predetermined information associated with an identity of a user involved in a transaction to which the transaction offset is to be applied, predetermined information associated with an identity of a merchant involved in a transaction to which the transaction offset is to be applied, a predetermined number of times that the transaction offset may be applied to a transaction, and/or the like.

In some non-limiting embodiments, transaction processing server 102 may determine whether to generate a transaction offset based on an input received from merchant system 108 (e.g., an input received from a merchant associated with merchant system 108). For example, transaction processing server 102 may determine to generate a transaction offset based on the input, where the input includes an indication to generate the transaction offset. In another example, transaction processing server 102 may determine not to generate a transaction offset where the input includes an indication not to generate the transaction offset. In some non-limiting embodiments, the input may be include a request to generate a transaction offset. In some non-limiting embodiments, the input may include information associated with the transaction offset (e.g., transaction offset application parameters of the transaction offset, reward parameters of the transaction offset, and/or the like). In some non-limiting embodiments, transaction processing server 102 may validate the input from the merchant based on a credential received from the merchant. For example, transaction processing server 102 may determine that the information associated with the transaction offset is invalid based on a merchant transaction offset authorization parameter, where the merchant transaction offset authorization parameter is determined by transaction processing server 102 based on the credential. In another example, transaction processing server 102 may determine that the information associated with the transaction offset is valid based on the merchant transaction offset authorization parameter.

In some non-limiting embodiments, transaction processing server 102 may determine (e.g., automatically) whether to generate a transaction offset based on information associated with a transaction and a merchant redemption rule. For example, transaction processing server 102 may determine whether to generate the transaction offset by comparing the information associated with the transaction (e.g., the information received by transaction processing server 102 in step 302) and merchant redemption rule criteria of the a merchant redemption rule. If the information associated with the transaction corresponds to the merchant redemption rule criteria of the merchant redemption rule, transaction processing server 102 may determine to generate the transaction offset. If the information associated with the transaction does not correspond to the merchant redemption rule criteria of the merchant redemption rule, transaction processing server 102 may determine not to generate the transaction offset. In some non-limiting embodiments, transaction processing server 102 may determine whether a transaction is associated with a chargeback, and transaction processing server 102 may determine to generate a transaction offset if additional information associated with the transaction (e.g., information associated with a transaction amount, information associated with a user, information associated with a merchant, and/or the like) corresponds to the merchant redemption rule criteria of the merchant redemption rule.

In some non-limiting embodiments, transaction processing server 102 may receive the merchant redemption rule criteria associated with a merchant redemption rule before receiving information associated with a transaction (e.g., the first transaction). For example, transaction processing server 102 may receive the merchant redemption rule criteria from a merchant associated with merchant system 108 before receiving the information associated with the first transaction.

In some non-limiting embodiments, the merchant redemption rule criteria may include a threshold value associated with a transaction amount of a transaction (e.g., a predetermined threshold value associated with a transaction amount, a predetermined minimum threshold value associated with a transaction amount, a predetermined maximum threshold value associated with a transaction amount, and/or the like), where a transaction offset is generated if a transaction amount of a transaction satisfies the threshold value associated with the transaction amount, a threshold value associated with a time of a transaction (e.g., a predetermined value associated with a time range of a transaction, a predetermined value associated with a time of day range of a transaction, a predetermined value associated with a date range of a transaction, a predetermined value associated with a time range from when the transaction offset was generated, and/or the like), where a transaction offset is generated if information associated with a time of a transaction satisfies the threshold value associated with the time of the transaction, information associated with an additional merchant (e.g., information associated an identity of the additional merchant, information associated with a merchant category of the additional merchant, and/or the like), where a transaction offset is generated if information associated with a transaction includes the information associated with the additional merchant, and/or the like. In some non-limiting embodiments, the additional merchant may have a relationship with the merchant involved in the first transaction (e.g., the transaction from which the transaction offset was generated).

Additionally or alternatively, the merchant redemption rule criteria may include a threshold value associated with a transaction history of a user (e.g., a predetermined threshold value of a number of transactions involving the user and a merchant, a predetermined threshold value of a transaction amount of a transaction involving the user and a merchant, a predetermined threshold value of an overall transaction amount of a plurality of transactions involving the user and a merchant, and/or the like), where a transaction offset is generated if the transaction history of the user satisfies the threshold value associated with the transaction history, information associated with a user (e.g., information associated with an identity of the user, information associated with an account of the user, and/or the like), where a transaction offset is generated if information associated with a transaction includes the information associated with the user, information associated with a merchant (e.g., information associated with an identity of the merchant, information associated with a merchant category of the merchant, information associated with a merchant account of the merchant, information associated with a product of the merchant, and/or the like), where a transaction offset is generated if information associated with a transaction includes the information associated with the merchant, and/or the like.

In some non-limiting embodiments, transaction processing server 102 may determine whether to generate a transaction offset based on information associated with the first transaction, a merchant redemption rule, and at least one of information associated with a user, information associated with a merchant, or any combination thereof. For example, transaction processing server 102 may determine whether to generate the transaction offset by comparing the information associated with the first transaction and the information associated with the user or the information associated with the merchant to the merchant redemption rule criteria of the merchant redemption rule. If the information associated with the transaction and the information associated with the user or the information associated with the merchant corresponds to the merchant redemption rule criteria of the merchant redemption rule, transaction processing server 102 may determine to generate the transaction offset. If the information associated with the transaction and the information associated with the user or the information associated with the merchant does not correspond to the merchant redemption rule criteria of the merchant redemption rule, transaction processing server 102 may determine not to generate the transaction offset.

In some non-limiting embodiments, transaction processing server 102 may determine to generate the transaction offset by accessing a data structure that is independent of merchant system 108 (e.g., independent of merchant associated with merchant system 108).

In some non-limiting embodiments, transaction processing server 102 may determine to generate the transaction offset based on determining that transaction offset application parameters of the transaction offset are valid based on a merchant transaction offset authorization level of a merchant associated with merchant system 108.

As further shown in FIG. 3, at step 306, process 300 includes generating the transaction offset. For example, transaction processing server 102 may generate (e.g., automatically) the transaction offset based on determining to generate transaction offset. In some non-limiting embodiments, transaction processing server 102 may generate a transaction offset with transaction offset application parameters received from a merchant (e.g., a merchant associated with merchant system 108). In some non-limiting embodiments, transaction processing server 102 may communicate a prompt (e.g., a prompt communicated via a user interface displayed by a client device associated with merchant system 108) to the merchant, and transaction processing server 102 may receive transaction offset application parameters from the merchant after communicating the prompt.

In some non-limiting embodiments, transaction processing server 102 may generate a transaction offset with transaction offset application parameters generated (e.g., automatically) based on a merchant redemption rule. For example, transaction processing server 102 may determine to generate a transaction offset based on the merchant redemption rule, and transaction processing server 102 may generate the transaction offset with transaction offset application parameters based on merchant redemption rule criteria. In some non-limiting embodiments, the transaction offset application parameters may be the same or different than the merchant redemption rule criteria. For example, if the merchant redemption rule criteria includes a threshold value associated with a transaction amount of a transaction, then transaction processing server 102 may generate the transaction offset with transaction offset application parameters that include the threshold value associated with the transaction amount of the transaction. Accordingly, the transaction offset may be applied to a transaction (e.g., a second transaction) when a transaction amount of the transaction satisfies the threshold value associated with the transaction amount of the transaction offset application parameters. In another example, if the merchant redemption rule criteria includes a threshold value associated with a transaction amount of a transaction, then transaction processing server 102 may generate the transaction offset with transaction offset application parameters that include a threshold value associated with a time of a transaction. Accordingly, the transaction offset may be applied to a transaction (e.g., a second transaction) when a time of the transaction satisfies the threshold value associated with the time of the transaction offset application parameters.

In some non-limiting embodiments, transaction processing server 102 may store information associated with the transaction offset (e.g., transaction offset application parameters of the transaction offset, an identifier of the transaction offset, and/or the like). For example, transaction processing server 102 may store the information in a data structure so that the information may be searched and/or may be obtained by transaction processing server 102. In some non-limiting embodiments, the data structure may be located within data storage device 114 associated with transaction processing server 102. In some non-limiting embodiments, transaction processing server 102 may store the information associated with the transaction offset in a data structure so the information associated with the transaction offset is associated with at least one of information associated with a user, information associated with a merchant, or any combination. Accordingly, the information associated with the transaction offset may be searched and/or obtained based on the information associated with a user, the information associated with a merchant, or any combination thereof.

In some non-limiting embodiments, transaction processing server 102 may generate the transaction offset based on determining that transaction offset application parameters of the transaction offset are valid based on a merchant transaction offset authorization level of a merchant associated with merchant system 108.

As further shown in FIG. 3, at step 308, process 300 includes communicating information associated with generating the transaction offset. For example, transaction processing server 102 may communicate (e.g., automatically) information associated with generating the transaction offset (e.g., information associated with an indication that the transaction offset was generated, transaction offset application parameters, information associated with a transaction based on which the transaction offset was generated, and/or the like) based on generating the transaction offset. In some non-limiting embodiments, transaction processing server 102 may communicate a message (e.g., a transaction offset notification message) that includes the information associated with generating the transaction offset. In some non-limiting embodiments, transaction processing server 102 may communicate the information associated with generating the transaction offset to issuer system 104, user device 106 (e.g., a user associated with user device 106, a merchant associated with user device 106, and/or the like), merchant system 108, and/or acquirer system 110. In some non-limiting embodiments, acquirer system 110 may receive the information associated with generating the transaction offset from transaction processing server 102, and acquirer system 110 may communicate the information to merchant system 108.

In some non-limiting embodiments, issuer system 104 may receive the information associated with generating the transaction offset from transaction processing server 102, and issuer system 104 may communicate the information to user device 106. In some non-limiting embodiments, issuer system 104 may communicate the information to user device 106 via a banking interface (e.g., an Internet banking interface, a mobile banking interface, and/or the like).

In some non-limiting embodiments, an issuer institution associated with issuer system 104 may include the information associated with the transaction offset in a message (e.g., an account statement, a credit account statement, a debit account statement, an electronic account statement, a physical account statement, a paper statement, and/or the like) to a user associated with an account that was issued by the issuer institution. In some non-limiting embodiments, the issuer institution communicate the message to a user device (e.g., user device 106) associated with the user.

As further shown in FIG. 3, at step 310, process 300 includes receiving information associated with a second transaction. For example, transaction processing server 102 may receive information associated with a second transaction (e.g., a transaction that occurs after the first transaction, one or more transactions that are subsequent to the first transaction, and/or the like) after generating the transaction offset. In some non-limiting embodiments, transaction processing server 102 may receive the information associated with the second transaction from merchant system 108. For example, transaction processing server 102 may receive the information associated with the second transaction as part of the second transaction being processed by transaction processing server 102. In some non-limiting embodiments, the information associated with the second transaction may be the same or similar as the information associated with the first transaction as described above.

As further shown in FIG. 3, at step 312, process 300 includes determining whether to process the second transaction by applying the transaction offset. For example, transaction processing server 102 may determine (e.g., automatically) whether to process the second transaction by applying the transaction offset. In some non-limiting embodiments, transaction processing server 102 may determine whether to process the second transaction based on information associated with the second transaction (e.g., information associated with a transaction amount of the second transaction, information associated with an identifier of the second transaction, information associated with a product involved in the second transaction, information associated with a time of the second transaction, information associated with a transaction type of the second transaction, information associated with a transaction status of the second transaction, information associated with a user (e.g., a customer, a consumer, and/or the like) involved in the second transaction, information associated with a merchant involved in the second transaction, information associated with an issuer institution that issued an account (e.g., a credit account, a debit account, and/or the like) involved in the second transaction, and/or information associated with the transaction offset (e.g., transaction offset application parameters of the transaction offset). For example, transaction processing server 102 may compare the information associated with the second transaction to the transaction offset application parameters of the transaction offset. If transaction processing server 102 determines that the information associated with the second transaction corresponds to the transaction offset application parameters, transaction processing server 102 may determine to process the second transaction by applying the transaction offset. If transaction processing server 102 determines that the information associated with the second transaction does not correspond to the transaction offset application parameters, transaction processing server 102 may determine not to process the second transaction by applying the transaction offset.

In some non-limiting embodiments, transaction processing server 102 may determine whether to process the second transaction based on information associated with a user (e.g., a user name included in the information associated with the second transaction), information associated with a merchant (e.g., a merchant name included in the information associated with the second transaction), and/or the information associated with the transaction offset. For example, if transaction processing server 102 determines that the information associated with the user and/or the information associated with the merchant corresponds to the transaction offset application parameters, transaction processing server 102 may determine to process the second transaction by applying the transaction offset. If transaction processing server 102 determines that the information associated with the user and/or the information associated with the merchant does not correspond to the transaction offset application parameters, transaction processing server 102 may determine not to process the second transaction by applying the transaction offset.

In some non-limiting embodiments, transaction processing server 102 may determine whether to process the second transaction by applying the transaction offset by accessing a data structure that is independent of the merchant. For example, transaction processing server 102 may search a data structure using information associated with a user and/or information associated with a merchant to obtain the transaction offset application parameters of the transaction offset. Transaction processing server 102 may determine whether to process the second transaction by applying the transaction offset based on the transaction offset application parameters obtained from the data structure.

In some non-limiting embodiments, transaction processing server 102 may determine whether to process the second transaction by applying the transaction offset based on a merchant redemption rule. For example, transaction processing server 102 may determine whether information associated with the second transaction satisfies the merchant redemption rule. If transaction processing server 102 determines that the information associated with the second transaction satisfies the merchant redemption rule, transaction processing server 102 may determine whether a transaction offset exists for a customer involved in the second transaction. Transaction processing server 102 may determine that a transaction offset exists for the customer based on information associated with the second transaction (e.g., information associated with an identity of the customer) by searching a data structure using the information associated with the second transaction. Upon determining that a transaction offset exists for the customer, transaction processing server 102 may determine to process the second transaction by applying the transaction offset to the second transaction. If transaction processing server 102 determines that the information associated with the second transaction does not satisfy the merchant redemption rule, transaction processing server 102 may determine that a transaction offset does not exist for the customer involved in the second transaction.

As further shown in FIG. 3, at step 314, process 300 includes processing the second transaction by applying the transaction offset to the second transaction. For example, transaction processing server 102 may process the second transaction by applying the transaction offset based on determining to process the second transaction. In another example, transaction processing server 102 may forego processing the second transaction by applying the transaction offset based on determining not to process the second transaction. In some non-limiting embodiments, transaction processing server 102 may process the second transaction by applying the reward parameter of the transaction offset to the second transaction. In some non-limiting embodiments, transaction processing server 102 may determine a modified transaction amount for the second transaction based on applying the transaction offset to the second transaction. For example, transaction processing server 102 may add a monetary discount associated with the transaction offset to the transaction amount of the second transaction. In some non-limiting embodiments, transaction processing server 102 may process the second transaction using the modified transaction amount of the second transaction.

In some non-limiting embodiments, transaction processing server 102 may communicate information associated with processing the second transaction by applying the transaction offset to the second transaction (e.g., information indicating the second transaction was processed by applying the transaction offset to the second transaction), based on processing the second transaction. For example, transaction processing server 102 may communicate a message (e.g., a transaction offset processing message) to issuer system 104, merchant system 108, and/or acquirer system 110, where the message includes information indicating the second transaction was processed by applying the transaction offset to the second transaction. In some non-limiting embodiments, issuer system 104 may communicate information associated with processing the second transaction based on processing the second transaction. For example, issuer system 104 may communicate a message to user device 106 associated with a user that is associated with an account involved in the second transaction. The account may be an account that was issued by an issuer institution associated with issuer system 104. Further, the message may include information indicating the second transaction was processed by applying the transaction offset to the second transaction.

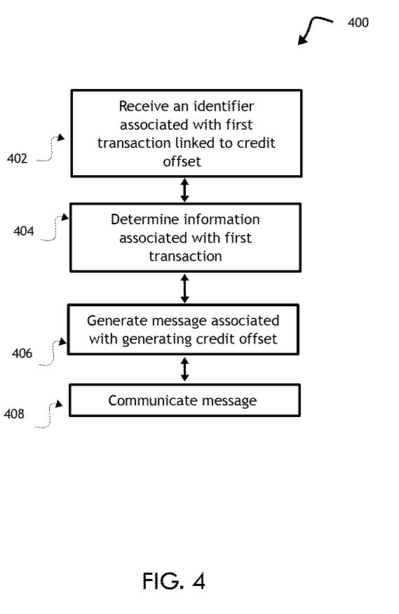

Referring now to FIG. 4, FIG. 4 is a flowchart of a non-limiting embodiment of a process 400 for communicating (e.g., automatically) information associated with generating a transaction offset (e.g., step 308 of process 300). In some non-limiting embodiments, one or more of the steps of process 400 may be performed (e.g., completely, partially, etc.) by transaction processing server 102. In some non-limiting embodiments, one or more of the steps of process 400 may be performed (e.g., completely, partially, etc.) by another device or a group of devices separate from or including transaction processing server 102, such as issuer system 104 (e.g., one or more devices of issuer system 104), user device 106, merchant system 108 (e.g., one or more devices of merchant system 108), or acquirer system 110 (e.g., one or more devices of acquirer system 110).

As shown in FIG. 4, at step 402, process 400 includes receiving an identifier associated with a first transaction linked to a transaction offset. For example, transaction processing server 102 may receive an identifier (e.g., a unique identifier, a transaction identifier, and/or the like) associated with a first transaction linked to transaction offset. In some non-limiting embodiments, the first transaction may be linked to a transaction offset based on information associated with the first transaction (e.g., the identifier) being stored with information associated with the transaction offset in a data structure. In some non-limiting embodiments, transaction processing server 102 may receive the identifier associated with the first transaction from merchant system 108 and/or acquirer system 110.

As shown in FIG. 4, at step 404, process 400 includes determining information associated with the first transaction. For example, transaction processing server 102 may determine (e.g., automatically) information associated with the first transaction (e.g., information associated with a user involved in the first transaction, information associated with a merchant involved in the first transaction, information associated with an issuer institution that issued an account involved in the first transaction, a transaction amount of the first transaction, information indicating the first transaction involved a chargeback, and/or the like) based on receiving the identifier associated with the first transaction. In some non-limiting embodiments, transaction processing server 102 may receive a credential from a merchant associated with merchant system 108, and transaction processing server 102 may determine the information associated with the first transaction based on validating the credential.

In some non-limiting embodiments, transaction processing server 102 may determine whether an issuer institution that issued an account involved in the first transaction is authorized to receive information associated with generating a transaction offset. For example, transaction processing server 102 may determine that the issuer institution is or is not enrolled in a program to receive messages associated with generating a transaction offset (e.g., a transaction offset notification message).

In some non-limiting embodiments, transaction processing server 102 may determine whether a transaction offset is linked to the first transaction. For example, transaction processing server 102 may determine whether a transaction offset is linked to the first transaction based on the identifier of the first transaction. In some non-limiting embodiments, transaction processing server 102 may determine whether a transaction offset is linked to the first transaction by searching a data structure (e.g., a data structure independent of a merchant associated with merchant system 108 and/or merchant system 108) that stores the information associated with the transaction offset.

In some non-limiting embodiments, transaction processing server 102 may receive information associated with a transaction offset by accessing the data structure. For example, after determining that a transaction offset is linked to the first transaction, transaction processing server 102 may search the data structure for transaction offset application parameters of the transaction offset using the identifier of the first transaction and may retrieve transaction offset application parameters based on searching the data structure.

In some non-limiting embodiments, transaction processing server 102 may communicate information associated with the first transaction and may receive information associated with a transaction offset after communicating the information. For example, transaction processing server 102 may communicate the information associated with the first transaction to merchant system 108, and a merchant associated with merchant system 108 may communicate transaction offset application parameters of a transaction offset to transaction processing server 102.

As shown in FIG. 4, at step 406, process 400 includes generating a message associated with generating a transaction offset. For example, transaction processing server 102 may generate (e.g., automatically) a message associated with generating a transaction offset based on determining information associated with the first transaction. In some non-limiting embodiments, transaction processing server 102 may generate a communication template (e.g., a cardholder communication template) that includes the transaction offset application parameters of the transaction offset. In some non-limiting embodiments, transaction processing server 102 may store the communication template. For example, transaction processing server 102 may store the communication template in a data structure that stores the information associated with the transaction offset.

As shown in FIG. 4, at step 408, process 400 includes communicating the message associated with generating the transaction offset. For example, transaction processing server 102 may communicate the message based on generating the message. In some non-limiting embodiments, transaction processing server 102 may communicate the message to issuer system 104, merchant system 108, and/or acquirer system 110. In some non-limiting embodiments, transaction processing server 102 may validate the message before communicating the message.

In some non-limiting embodiments, transaction processing server 102 may communicate the message to merchant system 108, where the message includes information indicating that a transaction offset is to be, is being, and/or was communicated to a user by an issuer institution (e.g., an issuer institution that issued an account associated with the user). In some non-limiting embodiments, issuer system 104 may communicate a message, which includes information associated with generating a transaction offset, to a user associated with an account issued by an issuer institution associated with issuer system 104. For example, the issuer institution may communicate the message to a user device (e.g., user device 106, a mobile device, and/or the like) associated with the user, may communicate the message via a letter to the user, and/or the like.

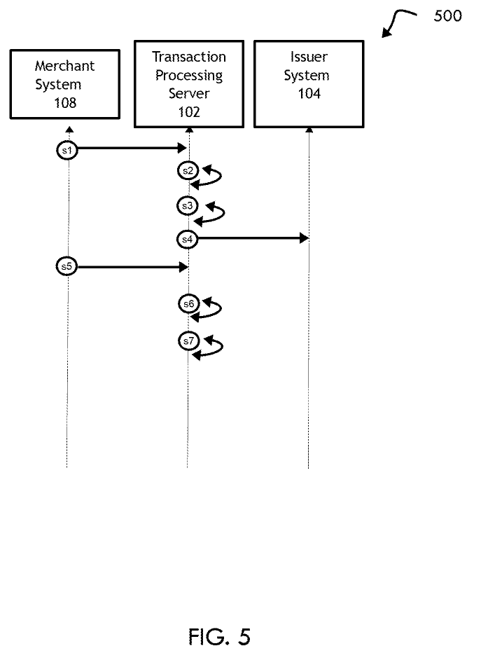

Referring now to FIG. 5, FIG. 5 is a sequence diagram of a non-limiting embodiment of a process 500 for providing a transaction offset based on a transaction. As shown, one or more of the steps of process 500 are performed (e.g., completely, partially, and/or the like) by transaction processing server 102, issuer system 104, and merchant system 108. Additionally or alternatively, one or more of the steps of process 500 may be performed (e.g., completely, partially, and/or the like) by another device or a group of devices separate from or including transaction processing server 102, issuer system 104, user device 106, merchant system 108, and acquirer system 110.

As shown in FIG. 5, at step s1, merchant system 108 may communicate information associated with a first transaction to transaction processing server 102. The first transaction may involve a customer and a merchant associated with merchant system 108. Further, the first transaction may involve an account of the customer. At step s2, transaction processing server 102 may determine whether to generate a transaction offset based on the information associated with the first transaction. In some non-limiting embodiments, transaction processing server 102 may determine whether to generate the transaction offset based on the information associated with the first transaction and a merchant redemption rule. At step s3, transaction processing server 102 may generate the transaction offset based on determining to generate the transaction offset.

As further shown in FIG. 5, at step s4, transaction processing server 102 may communicate information associated with generating the transaction offset to issuer system 104 based on generating the transaction offset. The information associated with generating the transaction offset may include a message that includes information associated with the transaction offset. At step s5, transaction processing server 102 may receive information associated with a second transaction from merchant system 108. At step s6, transaction processing server 102 may determine whether to process the second transaction by applying the transaction offset to the second transaction. At step s7, transaction processing server 102 may process the second transaction by applying the transaction offset to the second transaction based on determining to process the second transaction.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method, comprising:
receiving, with at least one processor, information associated with a first transaction between at least one customer and at least one merchant;
determining, with at least one processor, whether to generate a transaction offset based at least partially on the information associated with the first transaction and at least one merchant redemption rule, wherein determining to generate the transaction offset comprises accessing a data structure that is independent of the at least one merchant;
generating, with at least one processor, the transaction offset based on determining to generate the transaction offset;
communicating, with at least one processor, a transaction offset notification message based on generating the transaction offset;
receiving, with at least one processor, information associated with a second transaction involving the at least one customer and the at least one merchant;
determining, with at least one processor, whether to process the second transaction by applying the transaction offset to the second transaction based at least partially on the information associated with the second transaction and information associated with the transaction offset; and
processing, with at least one processor, the second transaction by applying the transaction offset to the second transaction based on determining to process the second transaction by applying the transaction offset to the second transaction.

2. The computer-implemented method of claim 1, wherein receiving the information associated with the first transaction comprises receiving a transaction offset generation request from a client device associated with the at least one merchant, wherein the transaction offset generation request comprises the information associated with the first transaction.

3. The computer-implemented method of claim 1, wherein the information associated with the transaction offset comprises at least one transaction offset application parameter, wherein the at least one transaction offset application parameter comprises at least one of:
a threshold value associated with a transaction amount of a transaction,
a threshold value associated with a time of a transaction,
predetermined information associated with an identity of a merchant,
predetermined information associated with an additional merchant, where the additional merchant has a relationship with the at least one merchant,
predetermined information associated with an identity of a user, or
any combination thereof.

4. The computer-implemented method of claim 1, wherein the at least one merchant redemption rule comprises merchant redemption rule criteria, wherein the merchant redemption rule criteria comprises at least one of:
a threshold value associated with a transaction amount of a transaction,
a threshold value associated with a time of a transaction,
a predetermined threshold value of a number of transactions involving the at least one customer and the at least one merchant,
information associated with at least one additional merchant, or
any combination thereof.

5. The computer-implemented method of claim 1, wherein the information associated with the first transaction comprises a transaction amount of the first transaction, and wherein determining to generate the transaction offset comprises:
determining to generate a transaction offset based at least partially on the transaction amount of the first transaction and the at least one merchant redemption rule.

6. The computer-implemented method of claim 1, further comprising receiving merchant redemption rule criteria associated with the at least one merchant redemption rule from the at least one merchant before receiving the information associated with the first transaction.

7. The computer-implemented method of claim 1, wherein generating the transaction offset comprises:
generating the transaction offset based on the at least one merchant redemption rule.

8. The computer-implemented method of claim 7, further comprising receiving a request to generate a transaction offset from a client device associated with the at least one merchant, and wherein determining whether to generate the transaction offset comprises:
determining to generate the transaction offset based on receiving the request to generate the transaction offset.

9. A system, comprising:
at least one processor, wherein the at least one processor is programmed or configured to:
receive information associated with a first transaction between at least one customer and at least one merchant;
determine whether to generate a transaction offset based at least partially on the information associated with the first transaction and at least one merchant redemption rule, wherein the at least one processor, when determining to generate the transaction offset, is to access a data structure that is independent of the at least one merchant;
generate the transaction offset based on determining to generate the transaction offset, wherein the transaction offset comprises transaction offset application parameters;
communicate a message based on generating the transaction offset;
receive information associated with a second transaction involving the at least one customer and the at least one merchant;
determine whether to process the second transaction by applying the transaction offset to the second transaction based at least partially on the information associated with the second transaction and transaction offset application parameters of the transaction offset; and
process the second transaction by applying the transaction offset to the second transaction based on determining to process the second transaction by applying the transaction offset.

10. The system of claim 9, wherein the at least one merchant is a first merchant wherein the at least one merchant redemption rule comprises merchant redemption rule criteria, wherein the merchant redemption rule criteria comprises at least one of:
a threshold value associated with a transaction amount of a transaction,
a threshold value associated with a time of a transaction,
a threshold value of a number of transactions involving the at least one customer and the at least one merchant,
information associated with a second merchant, or
any combination thereof.

11. The system of claim 9, wherein the message comprises information associated with generating the transaction offset, and wherein the at least one processor, when communicating the message, is further programmed or configured to communicate the message to at least one of:
a client device associated with the at least one merchant,
an issuer system associated with an issuer that issued an account associated with the at least one customer,
at least one acquirer system associated with an acquirer, or
any combination thereof.

12. The system of claim 9, wherein the information associated with the second transaction comprises information associated with an identity of the at least one customer, wherein the at least one processor, when determining whether to process the second transaction by applying the transaction offset to the second transaction, is further programmed or configured to:
determine whether to process the second transaction by applying the transaction offset to the second transaction based at least partially on the information associated with the identity of the at least one customer and the information associated with the second transaction.

13. The system of claim 9, wherein the at least one processor is further programmed or configured to:
communicate a transaction offset processing message based on processing the second transaction by applying the transaction offset to the second transaction.

14. The system of claim 9, wherein the at least one processor is further programmed or configured to:
determine information associated with an identity of the at least one customer based on the information associated with the first transaction;
determine information associated with a transaction history involving the at least one customer and the at least one merchant based on the information associated with the identity of the at least one customer; and
communicate the information associated with the transaction history involving the at least one customer and the at least one merchant to a client device associated with the at least one merchant.

15. A computer program product comprising at least one non-transitory computer-readable medium including one or more instructions that, when executed by at least one processor, cause the at least one processor to:
receive information associated with a first transaction between at least one customer and at least one merchant;
determine whether to generate a transaction offset based at least partially on the information associated with the first transaction and at least one merchant redemption rule, where the one or more instructions, that cause the at least one processor to determine to generate the transaction offset, cause the at least one processor to access a data structure that is independent of the at least one merchant;
generate the transaction offset based on determining to generate the transaction offset;
communicate a transaction offset notification message;
receive information associated with a second transaction involving the at least one customer and the at least one merchant;
determine whether to process the second transaction by applying the transaction offset to the second transaction based at least partially on the information associated with the second transaction; and
process the second transaction by applying the transaction offset to the second transaction based on determining to process the second transaction by applying the transaction offset.

16. The computer program product of claim 15, wherein the information associated with the first transaction comprises at least one of:
a transaction amount associated with the first transaction,
information associated with an identity the at least one customer,
information associated with an identity of the at least one merchant, or any combination thereof.

17. The computer program product of claim 15, wherein the one or more instructions further cause the at least one processor to:
receive merchant redemption rule criteria of the at least one merchant redemption rule from a client device associated with the at least one merchant before receiving the information associated with the first transaction.

18. The computer program product of claim 15, wherein the one or more instructions, that cause the at least one processor to generate the transaction offset, cause the at least one processor to:
generate the transaction offset based on the at least one merchant redemption rule and the information associated with the first transaction.

19. The computer program product of claim 15, wherein the at least one merchant is a first merchant, wherein the at least one merchant redemption rule comprises merchant redemption rule criteria, and wherein the merchant redemption rule criteria comprises at least one of:
a predetermined threshold value of a transaction amount associated with the second transaction,
a predetermined threshold value of time associated with the second transaction,
a predetermined threshold value of a number of transactions involving the at least one customer and the at least one merchant,
information associated with a second merchant, or
any combination thereof; and
wherein the one or more instructions, that cause the at least one processor to determine to generate the transaction offset, cause the at least one processor to:
determine to generate the transaction offset based at least partially on the information associated with the first transaction and the merchant redemption rule criteria of the at least one merchant redemption rule.

20. The computer program product of claim 15, wherein the one or more instructions further cause the at least one processor to:
communicate a transaction offset processing message based on processing the second transaction by applying the transaction offset to the second transaction.
